(19) United States
(12) Patent Application Publication
(10) Pub. No.: US 2026/0042542 A1
(43) Pub. Date: Feb. 12, 2026

(54) POWER SUPPLEMENT-BASED CONTROLLABLE LANDING METHOD AND SYSTEM FOR PARACHUTE LANDING TARGET, AND TARGET CONTROLLABLE LANDING METHOD AND SYSTEM

(71) Applicant: SHENYANG JIDONG TECHNOLOGY CO., LTD., Shenyang (CN)

(72) Inventors: Jun JIANG, Shenyang (CN); Xuezhu WANG, Shenyang (CN)

(21) Appl. No.: 19/259,565

(22) Filed: Jul. 3, 2025

Related U.S. Application Data
(63) Continuation of application No. PCT/CN2024/070995, filed on Jan. 7, 2024.

(30) Foreign Application Priority Data
Jan. 9, 2023 (CN) 202310029823.6

(51) Int. Cl. B64D 17/80; B64D 41/00

(52) U.S. Cl. CPC B64D 17/80; B64D 41/00

(57) ABSTRACT

A power supplement-based controllable landing method for a parachute landing target. The method includes: acquiring motion information of a parachute landing target; a power system (5; 5a-5h) meeting the parachute landing target, and being connected to the parachute landing target; and according to task requirements, reasonably allocating power resources to the power system (5; 5a-5h) and the parachute landing target in a power recombination manner, and driving the parachute landing target to move to a desired position, or to land in a desired state.

### CROSS-REFERENCE TO RELATED PRESENT APPLICATION

This application is a continuation of International Application No. PCT/CN2024/070995, filed on Jan. 7, 2024, which claims the priority of Chinese Patent Application No. 2023100298236 filed on Jan. 9, 2023 and entitled “POWER SUPPLEMENT-BASED CONTROLLABLE LANDING METHOD AND SYSTEM FOR PARACHUTE LANDING TARGET, AND TARGET CONTROLLABLE LANDING METHOD AND SYSTEM”, the disclosure of which is incorporated by reference herein in its entirety as part of the application.

### TECHNICAL FIELD

The present disclosure belongs to the technical field of air transportation, and in particular, relates to a power supplement-based controllable landing method and system for a parachute landing target, and a target controllable landing method and system.

### BACKGROUND

An aircraft, including a rocket, an airplane and a helicopter, is an extremely sensitive tool to weight. Specifically, the specific performance is that the tare weight to payload ratio is relatively large. The payload weight has a leverage effect on the overall weight of the system. A payload often needs an aircraft that is several to hundreds of times the tare weight of the payload. This is also why an aircraft often uses an airborne parachute with a very small tare weight to payload ratio to achieve inaccurate landing. In addition, in order to reduce the weight, such an aircraft often does not have a high-strength body, and the body is often deformed, damaged or even completely destroyed when being impacted. Moreover, the working mode is centered on aerial work, which often means disastrous consequences when losing power or control. Another performance of weight sensitivity of such a tool is that the requirements for the weight and the size of the target that the tool carries are often strict.

At present, the landing methods of the above aircraft and the target that the aircraft carries mainly include: controllable landing by self-power; and uncontrollable landing by parachute landing. A parachute is widely used in airdropping personnel and materials because the parachute is very light in weight with respect to the suspended target. As for an aircraft, emergency landing is often a last resort when the aircraft breaks down. Despite the buffer of the parachute, the landing of the aircraft is often accompanied by damage to the airframe of the aircraft.

As for a rocket, because the rocket body is a high-value target, using a parachute landing method often makes it difficult to achieve the effect of preserving the recovered rocket body, thus not having a good application prospect. Using a self-powered landing method means that the fuel and the power device needed for landing need to be lifted into an outer space. This part of “dead weight” will result in a lot of waste of resources, and it is difficult to design. In a word, because its own tare weight to payload ratio is very large, the use of its own power recovery may result in a greater cost. However, using a method for a parachute landing rocket body can only reduce the impact of the rocket body on ground objects to some extent, which is hardly helpful to save the rocket body itself.

For an airplane and a helicopter, when there are problems in their power systems, body structures or control systems, the airplane and the helicopter are often in danger of crashing. Considering the cost and the design, only a few small airplanes use a parachute landing method to protect people on board. However, this method of using parachutes to protect members in the airplane also has some limitations. For example, in mountainous areas with steep terrain or on water surfaces, since parachute landing makes it difficult to control the landing site, it is difficult to provide effective protection to members in the aircraft.

For an aircraft as the parachute landing target, because there is no effective control means, the delivered target often cannot reach the target site accurately, thus greatly reducing the delivery efficiency. Sometimes the receiving personnel cannot receive the target. It may even happen that the delivered target is thrown into places where the delivered target cannot be retrieved, such as a water surface and a valley, thus resulting in losses. On the other hand, the application scope of a traditional paradrop method is very limited.

On the other hand, the application of the above aircraft and the target that the aircraft carries also shows their sensitivity to weight.

### SUMMARY

In order to solve the above technical problems, an embodiment of the present disclosure provides a power supplement-based controllable landing method and system for a parachute landing target, and a target controllable landing method and system.

In order to achieve the above objective, the embodiment of the present disclosure uses the following technical solution.

A first aspect of the present disclosure discloses a power supplement-based controllable landing method for a parachute landing target. The method includes:
acquiring motion information of a parachute landing target, and obtaining a desired state required for a power system to be intersected with the parachute landing target;
intersecting and connecting the power system with the parachute landing target; and
reasonably allocating, by the power system and the parachute landing target, power resources in a power recombination manner according to task requirements, and driving the target to move to a desired position or land in a desired state;
where the power system includes a driving device for providing a controllable driving force to the target.

In some embodiments, the power recombination includes the connecting of the power system with the parachute landing target, and throwing away or retracting the parachute after connecting.

In some embodiments, the power recombination includes optimizing the structure and/or composition of the power system for one or more times in combination with the task requirements.

In some embodiments, after the power system docked with the parachute landing target, according to the task requirements, the method further includes adjustment, where the adjustment includes changing a relative pose of the power and the target in a target body coordinate system, and/or changing the relative pose of the power and the target in a global coordinate system.

In some embodiments, according to the task requirements, power recombination and adjustment can occur in the required number and order.

In some embodiments, the structure and/or composition of the power system are optimized according to the task requirements before the power system docks with the parachute landing target.

A second aspect of the present disclosure discloses a target controllable landing method based on parachute landing and power supplement. The method includes:
a parachute landing stage, in which a state of a target is controlled in a parachute landing manner; and
a power supplement stage, which is implemented by using the power supplement-based controllable landing method, so that the target moves to a desired position in a desired state or lands in a desired state.

A third aspect of the present disclosure discloses a power supplement-based system for a parachute landing target, where the system includes at least one power supplement-based unit; and
a state observation system, which is configured to acquire state information of a target; and
a control system, which is electrically connected with the power supplement-based unit and the state observation system;
where
the power supplement-based unit includes: a power system, which is configured to provide controllable power to a state of the target, where the power system includes a power supplement-based aircraft; and a connection assembly, where the connection assembly is configured to connect the power system with the target, and is arranged in the power system;
where the power supplement-based aircraft is an aircraft powered by a power driving device or a combination of a plurality of aircrafts.

In some embodiments, the power system further includes a dedicated power system which includes at least one power driving device, and the power driving devices are connected and the dedicated power system and the power supplement-based aircraft are connected through connectors; and the connector between the dedicated power system and the power supplement-based aircraft has controllability.

In some embodiments, the power system further includes a booster system which includes at least one power driving device, the power driving devices are connected and the booster system and the power supplement-based aircraft are connected through connectors.

In some embodiments, the power system employs a driving device with bidirectional or multidirectional power driving capability, or a combination of several driving devices.

In some embodiments, the connection assembly includes a fall-catch assembly; the fall-catch assembly includes: a carrier; and
a fastening device is arranged on the carrier for fixing a target.

In some embodiments, the connection assembly includes a cooperative connection assembly which includes a locking mechanism and a connection member which is arranged on the target and cooperates with the locking mechanism.

In some embodiments, the state observation system includes a device configured to acquire the state of the target; or
the state observation system includes a device configured to acquire the state of the target and the power system state; or
the state observation system includes a device configured to acquire the power system state and a motion state of the target with respect to the power system.

In some embodiments, the control system includes a controller arranged on the power supplement-based system, or a controller outside the power supplement-based system, and combinations thereof.

A fourth aspect of the present disclosure discloses a target controllable landing system based on parachute landing and power supplement. The system includes at least one parachute and the aforementioned power supplement-based system.

Compared with the prior art, the technical solution of the present disclosure has the following beneficial effects.

The present disclosure is more efficient. According to the present disclosure, the recoverable aerial target has the advantages of light weight of the parachute landing method and accurate controllability, so that the system can utilize the flying weight very efficiently. From the point of view of energy utilization efficiency, the rocket launch and recovery system using this method may avoid carrying a lot of “dead weight” including auxiliary devices such as fuels for recovery and landing gears, thereby greatly improving the utilization rate of rocket fuels, and further greatly improving the comprehensive performance of the rocket. From the point of view of time utilization of recovery, this method can quickly recover parachute landing targets scattered everywhere to one place, thereby improving the work efficiency of ground personnel who spend a lot of time collecting parachute landing targets.

The present disclosure is safer. A safe landing method is provided to parachute landing objects, so that parachute landing objects can land in a safe landing area, avoiding the potential threat of a harsh landing environment to parachute landing objects, and avoiding the adverse effects resulted from destructive impact, overturning and the like through the controllable landing motion state. The above situation is also applicable to the carried targets and personnel, so as to achieve the effect of protecting the safety of personnel and the safety of targets.

The present disclosure is more accurate. An accurate landing method is provided to parachute landing objects, which effectively avoids the inaccuracy that the parachute landing method itself has. For objects that must return to the designated recovery place, the present disclosure can avoid the consequences of task failure. In addition to the accurate control of the recovery or landing site, the present disclosure can achieve the accurate control of the recovery or landing action, thereby providing a gentle landing action to the recovered target, making the recovered target slightly stressed and achieving a better protection effect.

The present disclosure is more flexible. The method proposed in the present disclosure can provide a variety of flexible power configurations to the parachute landing target, and can supplement different power sources to the parachute landing target for different application scenarios to achieve different performances and meet different task requirements. For example, for long-distance recovery, the method of stamping parachutes and supplementing propeller power can be used to achieve efficient long-distance recovery and landing. For the high-altitude recovery target, the spin landing can be achieved by supplementing a rotor at high altitude and using the potential energy.

The cost-effectiveness ratio is high. For the recovery application, because there is no “dead weight” in the flying target body, the transportation efficiency of the aircraft is greatly improved. Especially for the rocket system with a very large lifting distance, eliminating the “dead weight” has a great role in improving the cost-effectiveness ratio of the system.

### BRIEF DESCRIPTION OF THE DRAWINGS

FIG. 1 is a structural block diagram of a power supplement-based system according to an aspect of the present disclosure;

FIG. 2 is a structural block diagram of a power mode I of a power system according to an aspect of the present disclosure;

FIG. 3 is a structural block diagram of a power mode II of a power system according to an aspect of the present disclosure;

FIG. 4 is a structural block diagram of power mode III of the power system according to an aspect of the present disclosure;

FIG. 5 is a structural block diagram of a power mode IV of a power system according to an aspect of the present disclosure;

FIG. 6 is a structural block diagram of a power mode V of a power system according to an aspect of the present disclosure;

FIG. 7 to FIG. 14 are schematic structural diagrams of embodiments of a connection assembly according to the present disclosure; and

FIG. 15 to FIG. 26 are schematic diagrams of embodiments of a method and a system according to the present disclosure.

In the figures:

1—target, 2—parachute, 21—parachute control device, 3—power supplement-based system, 4—power supplement-based unit, 5—power system, 6—connection assembly, 7—state observation system, 8—control system; 51—power supplement-based aircraft, 52—dedicated power system, 53—booster system, 54—connector; 611—fall-catch assembly, 6101—carrier, 6102—baffle; 612—fall-catch assembly, 6103—disk-shaped carrier, 6104—hook and loop; 621—cooperative connection assembly, 6201—bracket, 6202—mechanical arm, 6203—connection device, 6204—ball-shaped connection member; 622—cooperative connection assembly, 6205—annular bracket, 6206—locking block, 6207—connection ring; 623—cooperative connection assembly, 6208—receiver, 6209—locking mechanism, 6210—bracket, 6211—connection member, 6212—flexible member; 624—cooperative connection assembly, 6213—mechanical arm, 6214—connection device, 6215—ball-shaped connection member; 625—cooperative connection assembly, 6216—connection device, 6217—ball-shaped connection member; 626—cooperative connection assembly, 6218—bracket, 6219—clamp, 6220—horizontal bar-shaped connection member; 63—transfer assembly, 6301—guide rail, 6302—slider; 11—target aircraft; 41—power supplement-based unit, 5a—power system, 511—multi-rotor aircraft, 521—booster rocket, 531—booster rocket; 12—materials; 5b—power system, 5121—helicopter, 211—parachute retractor, 5122—vertical takeoff and landing aircraft; 13—rocket body to be recovered; 5c—power system, 513—helicopter ; 5d—power system, 51401—multi-rotor helicopter, 51402—rocket propulsion device; 5e—power system, 515—helicopter , 522—jet engine; 42—power supplement-based unit, 5f—power system, 516—helicopter ; 5g—power system, 517—helicopter; 5h—power system, 518—aircraft.

### DETAILED DESCRIPTION OF THE EMBODIMENTS

The present disclosure will be further explained with reference to the detailed description, but it is not limited to the present disclosure. The structures, proportions, sizes and the like shown in the attached drawings of the specification are only used to cooperate with the contents disclosed in the specification for those skilled in the art to understand and read, rather than limit the conditions that can be implemented by the present disclosure, which therefore has no technical significance. Any modification of the structure, change of the proportion relationship or adjustment of the size should still fall within the scope that can be covered by the technical content disclosed by the present disclosure without affecting the efficacy and the objective that can be achieved by the present disclosure. At the same time, the terms such as “upper”, “lower”, “front”, “rear” and “middle” quoted in this specification are only for the convenience of description, rather than limit the scope that can be implemented by the present disclosure. The change or adjustment of the relative relationship should also be regarded as the scope that can be implemented by the present disclosure without substantially changing the technical content.

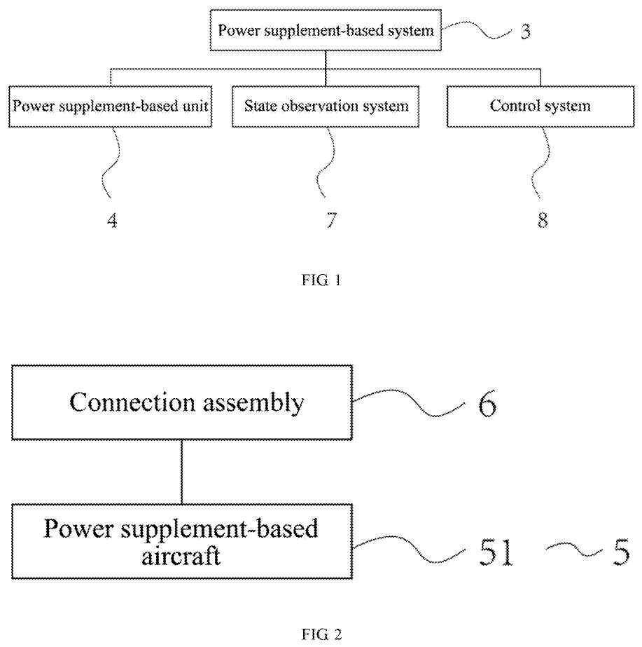

Referring to FIG. 1, the present disclosure discloses a power supplement-based system for a parachute landing target, which is used to add or supplement power to the target or provide independent landing power to the target, so that the parachute landing target has the ability to recover/land in a controllable manner. The power supplement-based system 3 includes a power system 5, where the power system 5 provides controllable power to the target; and a connection assembly 6, where the connection assembly 6 is configured to connect the power system with the target and establish the mechanical connection between the power system and the target, and the connection assembly 6 is arranged on the power system 5; and a state observation system 7, where the state observation system 7 is configured to acquire state information of the target; and a control system 8, where the control system 8 controls the power system 5 to be intersected with the target and dock with the target through the connection assembly 6 according to the information fed back by the state observation system 7 and the state information of the power system 5 and controls the target to move to a desired position in a desired state. The control system 8 is electrically connected with the power system 5, the connection assembly 6 and the state observation system 7

The power system 5 is provided with a variety of power combined modes. In the power mode I, as shown in FIG. 2, the power system 5 includes a power supplement-based aircraft 51. The power supplement-based aircraft 51 is an aircraft powered by a power driving device or a combination of a plurality of aircrafts, and has sufficient motion capability and control accuracy to meet the requirements of efficient and reliable connection between the power system 5 and the target.

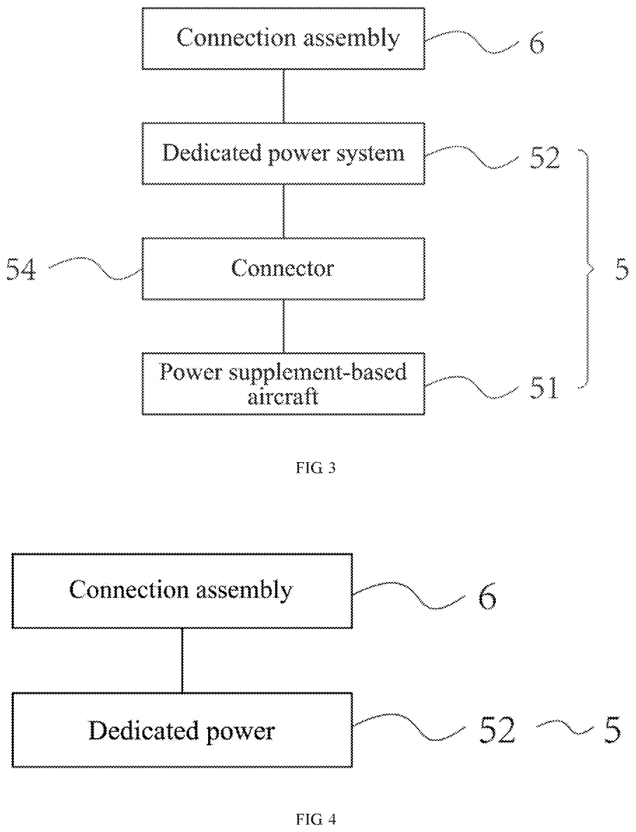

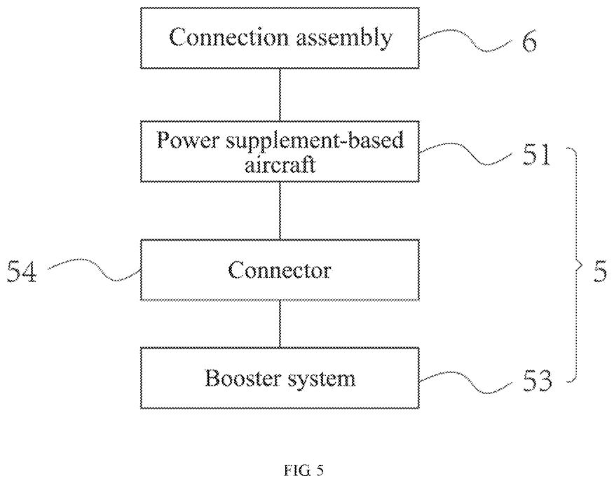

In the power mode II, as shown in FIG. 3, in some embodiments, the power system 5 includes a power supplement-based aircraft 51 in the power mode I and a dedicated power system 52. The dedicated power system 52 has comprehensive performance suitable for task requirements. For example, in the task requiring a large thrust-to-weight ratio, a solid rocket with an appropriate size can be selected as the dedicated power system 52. The dedicated power system 52 includes at least one power driving device, which is selected as different power driving devices and a combination of various driving devices according to different tasks. The power driving devices in the dedicated power system 52 are connected and the dedicated power system and the power supplement-based aircraft are connected through a connector 54. At least the connector 54 between the dedicated power system 52 and the power supplement-based aircraft 51 has controllability to enable engagement or disengagement of devices at both ends of the connector 54.

Of course, if the dedicated power system 52 and the power supplement-based aircraft 51 are fixedly connected throughout the execution of the task, this configuration can be regarded as the power mode I. In this case, the connector 54 between the dedicated power system 52 and the power supplement-based aircraft 51 is regarded as a part of the power mode I.

In the power mode III, as shown in FIG. 4, in some embodiments, the power system 5 includes the dedicated power system 52 in the power mode II, or only includes part of the power of the dedicated power system 52 in the power mode II.

In the power mode IV, as shown in FIG. 5, in some embodiments, the power system 5 includes a power supplement-based aircraft 51 in the power mode I and a booster system 53, whose function is to provide the power system 5 with some flight performance suitable for completing the task. For example, using a booster rocket as the booster system 53 enables the power system 5 to be intersected with the target quickly. The booster system 53 includes at least one power driving device, which is selected as different power driving device adaptation solutions according to different tasks. The power driving devices in the booster system 53 are connected, and the booster system 53 and the power supplement-based aircraft 51 are connected through a controllable connector 54. At least the connector 54 between the booster system 53 and the power supplement-based aircraft 51 has controllability to enable engagement or disengagement of devices at both ends of the connector 54. The booster system 53 is disengaged from other parts of the power system 5 before the power system 5 docks with the target. The booster system 53 does not re-participate in the subsequent tasks any more after being disengaged.

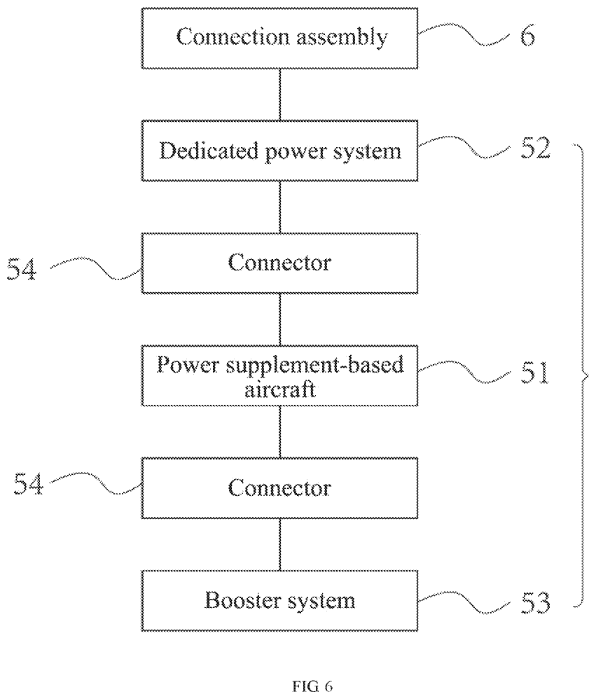

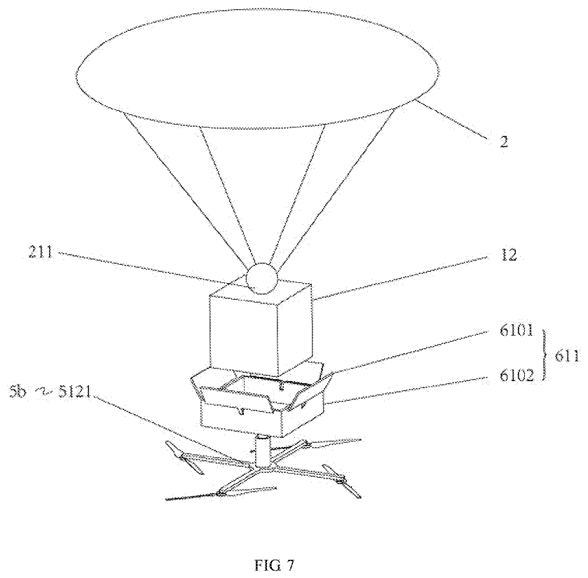

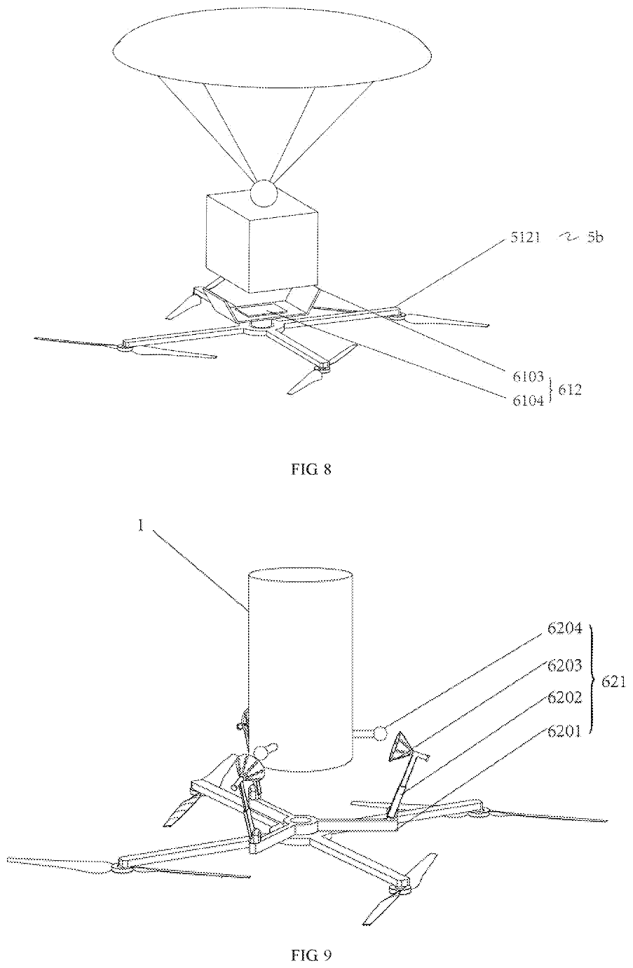

In the power mode V, as shown in FIG. 6, in some embodiments, the power system includes a power supplement-based aircraft 51 in the power mode I, a dedicated power system 52 in the power mode II, and a booster system 53 in the power mode IV. The power supplement-based aircraft 51, the dedicated power system 52, and the booster system 53 are connected through controllable connectors 54 to enable engagement or disengagement of devices at both ends of the connector 54.

The above connector 54 uses a universal connection mechanism or device, which is only used to enable engagement and fixed connection or disengagement and release of the devices at both ends. The implementation solution is conventional design, which is not described in detail here.

The form of the driver of the power driving device uses all feasible forms in the prior art, including but not limited to: a propeller, a ducted propeller, an air jet engine, a rocket driver and a combination of the above. The power source of the driver uses all feasible power sources in the prior art, including but not limited to: a motor, a piston engine, an air jet engine, a rocket engine and a combined engine. The layout of the driver uses all feasible layouts, including but not limited to: a single-rotor type with a tail rotor, a coaxial twin-propeller type, a tandem/side-by-side twin-propeller type, an intermeshing type, a multi-rotor type, or other configurations according to power requirements.

The dedicated power system 52 is an aircraft or a controllable power device powered by the above power driving device and a combination of a plurality of aircraft or controllable power devices for a specific task.

In some embodiments, the power system 5 uses a driving device with bidirectional power driving capability, or a combination of several such driving devices. For example, the power system with a coaxial twin-propeller driving device can achieve the upward and downward driving force direction with respect to its body. The advantage of using bidirectional power is that when the relative orientation of the target and the power system needs to be flexibly adjusted/arranged, the driving direction can be controlled to adapt to the change of the relative orientation. For example, after the power system docked with a slender target under the slender target, the slender target can be placed under the power system by adjustment, and the driving force of the power system changes the direction with respect to itself so that the combined system is still balanced. Further, in some applications, multi-directional driving devices or the combination thereof can be provided to achieve more flexible control. For example, the driving device is a rocket propulsion system, and an engine with a lateral injection function in the main thrust direction can be used to provide a rolling and tilting torque to the combination of the target and supplemented power, so as to better adjust the pose.

In some embodiments, the power system 5 and the connection assembly 6 on the power system form a power supplement-based unit 4. The power supplement-based system 3 includes several power supplement-based units 4. The power supplement-based units 4 cooperatively perform tasks to complete the target power supplement.

According to different applications, the connection assembly of the present disclosure uses different docking modes, that is, a fall-catch mode and a cooperative docking mode.

A fall-catch assembly 611, 612 is connected with the target in a lifting manner. Usually, the connection assembly is provided with a carrier for accommodating the target, and the target falls into the carrier.

For the cooperative connection assembly 621, 626, the target is provided with a connection member that cooperates with the connection assembly. The cooperative connection assembly includes a rigid docking mode, a quasi-rigid docking mode and a flexible docking mode. The rigidity and the flexibility are only relative, rather than a strict distinction. Different solutions are used for the position where the connection assembly docks with the target according to different applications, for example, the connection assembly can dock with the bottom, the middle or the upper part of the target. If the connection position is the middle or the upper part of the target, the connection assembly can be sleeved outside the target.

For the connection assembly, the following embodiments are provided here.

As shown in FIG. 7, the connection assembly in Embodiment 1 of the present disclosure docks with a target using a fall-catch mode. The fall-catch assembly 611 includes a carrier 6101. Several baffles 6102 are arranged on the carrier 6101. The baffles 6102 are distributed on the contour of the carrier 6101. The baffle 6102 is turned outward, so that the receiver 6101 has a large tolerance when receiving the target. In some embodiments, the baffle 6102 has controllable turnover capability. Before the connection assembly docks with the target, the baffle 6102 is in an outward-turning state, allowing the connection assembly to have a large tolerance when docking with the target. The target falls on the carrier 6101, and the baffle 6102 turns inward to fix the target on the carrier 6101.

As shown in FIG. 8, the connection assembly in Embodiment 2 of the present disclosure docks with a target using a fall-catch mode. The fall-catch assembly 612 includes a disk-shaped carrier 6103. A magnetic attraction part or an adhesive part such as a hook and loop 6104 engaged with a target is arranged on the disk-shaped carrier 6103. The connection assembly can be applied to a target with iron-based or adhesive packaging. Iron-based or adhesive packaging materials can also be targeted to package the target, or cooperative magnetic attraction parts or an adhesive part such as a hook and loop can be arranged on the outer packaging of the target.

As shown in FIG. 9, the connection assembly in Embodiment 3 of the present disclosure docks with a target using a cooperative rigid docking implementation. Three mechanical arms are used to compensate for the large tolerance between the target and the power system, so that the power system docks with the target accurately. After docking, the mechanical arm can be locked by a specific mechanism after the mechanical arm is adjusted to the required state of the system, so that the mechanical arm can become a structural member, thus transmitting a large force. Specifically, the cooperative connection assembly 621 includes a bracket 6201. Several mechanical arms 6202 are reasonably distributed on the bracket 6201. A free end of the mechanical arm 6202 is provided with a trumpet-shaped connection device 6203. A locking mechanism is arranged in the connection device 6203. A ball-shaped connection member 6204 cooperating with the connection device 6203 is arranged on the target.

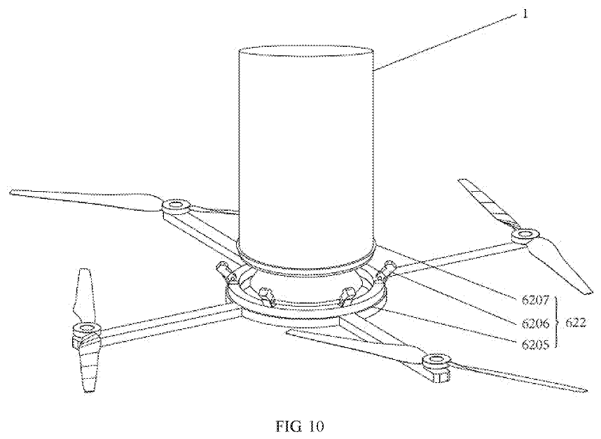

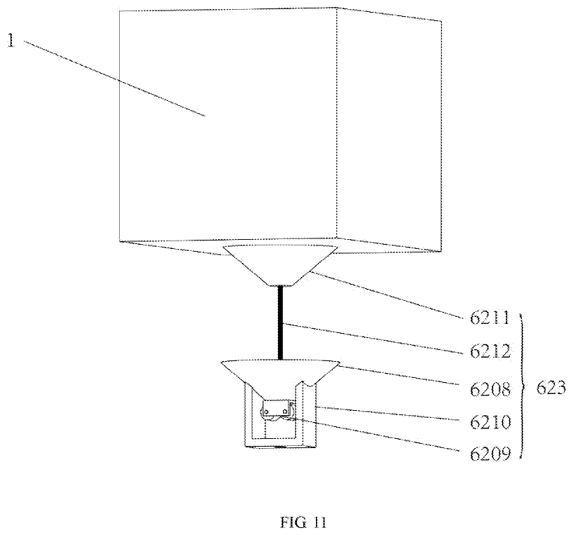

As shown in FIG. 10, the connection assembly in Embodiment 4 of the present disclosure docks with a target using a cooperative rigid docking implementation. The cooperative connection assembly 622 includes an annular bracket 6205. Several locking blocks 6206 with driving capability are distributed on the annular bracket 6205. A connection ring 6207 cooperating with the locking blocks 6206 is arranged on the target. The locking blocks 6206 are clamped with the connection ring 6207.

As shown in FIG. 11, the connection assembly in Embodiment 5 of the present disclosure docks with a target using a cooperative quasi-rigid docking implementation. The cooperative connection assembly 623 includes a funnel-shaped receiver 6208 with two open ends. The smaller opening end of the receiver 6208 is provided with a clamping locking mechanism 6209. The smaller opening end of the receiver 6208 is provided with a bracket 6210, and is connected with the power system 5 through the bracket 6210. The target is provided with an inverted funnel-shaped connection member 6211 cooperating with the receiver 6208. An end of the connection member 6211 is provided with a slender flexible member 6212. When the connection assembly docks with the target, the funnel-shaped receiver 6208 allows the connection assembly to have a large tolerance. The flexible member 6212 passes through the smaller opening of the receiver and is connected with the locking mechanism 6209. The locking mechanism 6209 pulls the flexible member 6212 to allow the connection assembly to dock with the target and be locked.

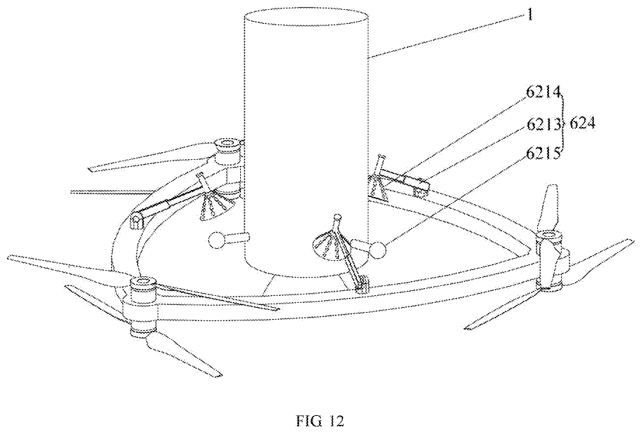

As shown in FIG. 12, the connection assembly in Embodiment 6 of the present disclosure docks with a target using a cooperative quasi-rigid docking implementation. If the target is a rocket body, the connection assembly can be sleeved outside the target to dock with the middle and the upper part in view of the situation of avoiding the nozzle. Specifically, in this embodiment, the aircraft uses an annular structure. The cooperative connection assembly 624 includes a mechanical arm 6213. The free end of the mechanical arm 6213 is provided with a trumpet-shaped connection device 6214. A locking mechanism is arranged in the connection device 6214. The target is provided with a ball-shaped connection member 6215 which cooperates with the connection device 6214. After docking, the mechanical arm 6213 is locked to protect the driver. Several cooperative connection assemblies 624 are distributed on the annular structure of the aircraft, and the target is also provided with the same number of ball-shaped connection members 6215 as the cooperative connection assemblies 624.

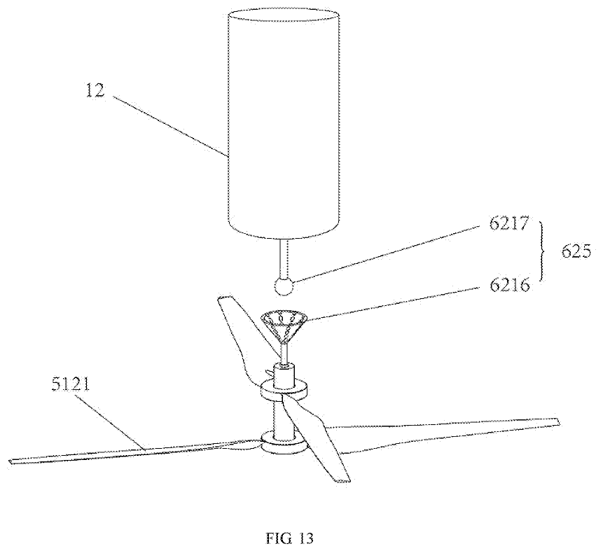

As shown in FIG. 13, the connection assembly in Embodiment 7 of the present disclosure docks with a target using a cooperative flexible docking implementation. In this embodiment, a single-ball docking solution is used, and the aircraft uses a coaxial twin-propeller form. The cooperative connection assembly 625 includes a horn-shaped connection device 6216. A locking mechanism is arranged in the connection device 6216. The connection device 6216 is arranged on the body of the twin-propeller axis. The target is provided with a ball-shaped connection member 6217 which cooperates with the connection device 6216. Normally, the connection member 6217 is arranged below the target. When using this embodiment to dock with the target, three rotational degrees of freedom remain after docking.

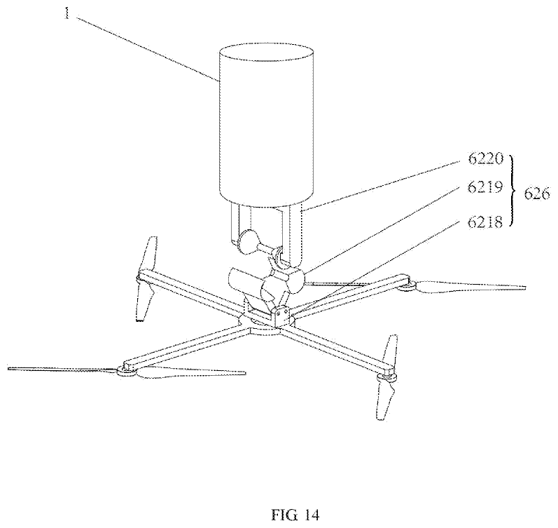

As shown in FIG. 14, the connection assembly in Embodiment 8 of the present disclosure docks with a target using a cooperative flexible docking implementation. In this embodiment, a horizontal bar-shaped docking solution is used, and a horizontal bar-shaped connection member 6220 is arranged on the target. The cooperative connection assembly 626 includes a bracket 6218. The bracket 6218 is provided with a clamp 6219 which cooperates with the horizontal bar-shaped connection member 6220 and has controllable opening and closing capability. When using this embodiment to dock with the target, one rotational degree of freedom remains after docking.

For the rigid docking mode, the power system can be in any orientation, such as below, in the middle of and above the target, that can ensure controllable flight after docking. It is also possible to adjust the orientation of the target and the power system according to the actual needs. For example, if the power system is below the target when docking, it is possible to select to turn the target below the power system by the control means, thus forming a form in which the power system hangs the target.

For the quasi-rigid docking mode, the power system can be in any orientation, such as below, in the middle of and above the target, that can ensure controllable flight after docking. It is also possible to adjust the orientation of the target and the power system according to the actual needs. For example, if the power system is below the target when docking, it is possible to select to turn the target below the power system by the control means, thus forming a form in which the power system hangs the target.

For the flexible docking mode, if the power system is located below the target, the target is often in a static and unstable state. That is, if the power system does not perform active controlling, the target will overturn under the action of small disturbance and gravity, resulting in the inability to maintain all the stable states. The active inverted pendulum control can maintain the relative position relationship between the power system and the target, but it is often very expensive and not practical. For the case where the power system is below, it is preferable to place the target below the power system through active control, so as to achieve the static stablility form and facilitate the subsequent control and recovery work.

For the system that can form a static stablility state after docking, the relative orientation relationship when docking can be kept.

The state observation system is configured to measure the motion state of the target. The state observation system can be flexibly arranged at a position convenient for state observation, including, but not limited to, on a power supplement-based aircraft, on a dedicated power system, on other parts of the power supplement-based system, and on a combination of the above positions. In addition to the device of directly acquiring the relative state of the observed object, the state observation system further includes a plurality of sensors including inertial sensors on the power system and the combination thereof.

In some embodiments, the state observation system further includes a plurality of sensors including inertial sensors on the target and the combination thereof, as well as a device combination and an algorithm that achieve the fusion of multi-sensor information of the power system and the target through communication between the power system and the target to obtain better state observation ability.

In some embodiments, the state observation system further includes a differential positioning system, a ground radar, and the like.

In some embodiments, the target is provided with an identification point. The identification point facilitates the identification and measurement of the state observation system. Preferably, the identification point is arranged on the connection member of the target or the connection part of the target, so as to obtain more accurate motion state information of the connection part.

The control system is arranged on the power system or other suitable places. The control system can also be dispersed in various components of the whole system. The control algorithm can use a centralized calculation method with a single master controller or use a distributed calculation method with a plurality of controllers. The control system can acquire the state information of each component of the power supplement-based system, acquire the target state information through the observation system or the third-party information source, and control each component of the power supplement-based system at each stage of task execution.

In some embodiments, a parachute control device is arranged on the target, and the parachute control device is electrically connected with the control system. The parachute control here includes disconnecting the connection between the parachute and the target, controlling the parachute to achieve specific power requirements, retracting the parachute to eliminate the original aerodynamic force of the parachute, and changing the parachute type or structure to change the power of the parachute. The achievements of the above parachute control objective are all in the prior art. Therefore, the specific structure of the parachute control device is not described in detail here.

On the other hand, the present disclosure discloses a target controllable landing system based on parachute landing and power supplement, which includes a parachute and the above-mentioned power supplement-based system. According to the task setting, the target reaches the predetermined airspace or state to implement jettisoning. The target enters the landing procedure after moving to a certain stage of the task in air, and the target is recovered through the target controllable landing system of the present disclosure. When the target reaches the set area or state, the parachute is opened. The power supplement-based system starts the power system to be intersected and dock with the target at the right time, and controls the target to move to the desired position in the desired state or land in the desired state.

In some embodiments, the parachute can be manipulated to become a part of controllable power components, especially a ram-air parachute.

The present disclosure provides a power supplement-based controllable landing method for a parachute landing target, which provides controllability or improves the controllability of the parachute landing target through a power system, so that the target moves to a desired position in a desired state or lands in a desired state.

Step 1, the motion information of the parachute landing target is acquired, and the intersection point or the intersection area is calculated.

According to the task requirements, in combination with the motion information of the target and the dynamic performance of the power system, the point intersected with the target in space can be found, which is referred to as the intersection point. The task requirements referred to here include, but are not limited to minimum fuel consumption, minimum time consumption, minimum distance, etc., as well as comprehensive indicators combining the above indicators. The intersection point can usually be calculated by an optimal control method. Taking the factors, such as the necessary safety distance, the sensor accuracy and the observation range of the observation device, into account, the intersection point can be expanded into a reasonable area by an algorithm, which is referred to as the intersection area.

The relative motion information between the target and the power system is acquired through the state observation system, and the intersection area is calculated, or the motion information of the target is estimated, and the intersection area is calculated. The state observation system may be a navigation positioning system with the ability to acquire global coordinates or motion state and necessary communication means, such as a Global Position System (GPS)/a differential GPS/an integrated navigation system and wireless communication. The state observation system may also be the observation device and means between the power system and the target in which one party unidirectionally detects the other party, such as a radar and an optical observation device. The state observation system can also provide a specific physical signal by one party, and can infer the motion state of the signal provider through the change law of the physical signal via a corresponding device and method by the other party, for example, the target emitting a signal with a specific wavelength in the landing process. The ground observation system can measure its motion state through the Doppler effect. The state observation system can be a combination and a deep fusion of the above methods.

In some embodiments, before the power system actively approaches the parachute landing target, the relative distance between the power system and the parachute landing target is far. At this distance, it is difficult for the power system to observe the motion state of the target with high precision. Usually, the motion information of the target can be obtained through the information provided by the third party or according to the motion state information actively emitted by the target.

In some embodiments, the movement route and time of the parachute landing target can be estimated according to the task planning, and the close-in observation can be performed according to this estimated time and the intersection area to acquire the accurate motion state of the target.

Step 2, the power system moves to the intersection point or the intersection area and is intersected with the parachute landing target.

In combination with the motion information of the target and the dynamic performance of the power system, the motion trajectory needed for the intersection is calculated. When necessary, the motion trajectory can be adjusted in real time according to the real-time state information of the target and the power system. Alternatively, more simply, only the desired motion state of the power system is given. The power system starts from the starting point at the right time, and the power system gradually approaches the target as planned.

In some embodiments, the motion trajectory is calculated from the position of the dropping area and some necessary information, for example, the specific coordinates when dropping, the motion state of the target body when dropping, meteorological information, etc. Based on a mathematical model, a database and a solving method, the motion trajectory of the intersection is calculated.

In some embodiments, in the case that the motion trajectory of the target body is not known in advance, the intersection area can be obtained online according to the motion state of the parachute landing target obtained online in combination with the motion ability of the power system. The power system moves based on the motion trajectory obtained online.

In some embodiments, the composition of the power system is optimized according to the task requirements. For example, the power system needs to reach the intersection expectation at a high speed, and the intersection can be accelerated by the combination of special power. For example, a power system of a booster system is used. Specific modes include the power mode IV and the power mode V of the above power system. The booster system is generally disengaged from other parts of the power system before docking.

In some embodiments, in order to achieve the objective of rapid intersection between the power system and the target, the power system can be carried on an aircraft and wait in the vicinity of the intersection area in advance. When the intersection and docking tasks are triggered, the power system starts from the aircraft on which the power system is carried to arrive at the intersection area nearby.

In some embodiments, the power system flies in formation with the parachute landing target according to the data of the state observation system. In some embodiments, for the docking operation, the state observation system has the ability to acquire global coordinates or motion state, and the accuracy is high enough, such as the differential GPS system in large-tolerance operation tasks. Therefore, the global positioning device can also be used for docking operation.

In some embodiments, the state observation system does not have the ability to obtain global coordinates or motion state, or the accuracy is not high enough. It is necessary to achieve the high-precision observation required for docking through the system combination that improves the relative positioning precision via a staged and progressive process. For example, the state observation system can be achieved in two stages with ground radar detection cooperating with an airborne high-precision optical observation system of the power system. The specific implementation process can be that the ground radar performs detection all the time, and after the target is found, the power system flies to the intersection area of calculation. After the target enters observation range of the airborne optical observation system of the power system, the power system accurately determines the relative motion state of the target with respect to the power system through the airborne optical observation system, which provides a basis for docking. The radar detection stage in this embodiment can also be achieved by the global positioning system. In most cases, according to the reasonable task planning, when the target and the power system are intersected with each other, the target should be within the observation range of the airborne optical observation system. If it is impossible to perform observation directly after the intersection, the target can enter the measurement range of the airborne optical observation system by adjusting its own state, the state of the airborne optical observation system or both. The power system obtains the precise state of the target. According to this state, the power system and the target fly in close formation, so that the connection member or the connection part on the target enters the operating range for power system docking.

Step 3, the power system docks with the parachute landing target.

After obtaining the precise relative motion state of the target, the power system moves to the appropriate relative position according to the docking solution, which facilitates the subsequent docking operation. For example, if the connection assembly of the target is located at its bottom, the power system should move to the bottom of the target, and make the connection assembly close to the corresponding position of the target.

In the docking process, the power system should select the appropriate motion route according to the measurement range and adjustment ability of the state observation system to ensure the effective observation of the target by the state observation system in the docking process.

At the same time, before the docking operation, the power system should keep a safe distance from the target to avoid the collision between the power system and the target due to sudden disturbance. In the case of quitting the docking operation, a certain safe distance is kept to facilitate the smooth disengagement of the power system and the target when the task is temporarily cancelled.

In some embodiments, when a plurality of power systems dock with the target, each power system should move to its own connection position, so as to perform docking operation at the same time when necessary.

In some embodiments, when the motion capability and the motion precision of the power system are sufficient to meet the docking tolerance, the docking/joining between the power system and the target can be achieved by directly connecting the power system with the target. This method is suitable for the power system with very high dynamic controllability and motion precision.

In some embodiments, when direct docking/joining cannot be achieved, the docking/joining between the power system and the target is often achieved by large tolerance guidance. This method can be used for most flexible connection modes.

In some embodiments, when the motion capability of the power system cannot directly compensate for the difference in the motion state between the power system and the target, an active high dynamic docking mode can be used to achieve accurate docking. For example, a mechanical arm is used to achieve high dynamic docking.

In some embodiments, when the relative state of the connection assemblies at both ends is reduced to be small enough, the locking device of the connection assembly is activated to lock the connection assemblies at both ends together. After locking, the degree of freedom between the connection assemblies at both ends depends on the characteristics of the connection assemblies. For pure rigid docking, the degree of freedom between the connection assemblies at both ends is zero. For flexible docking of suspended ropes, the degree of freedom between the connection assemblies at both ends is five. For ball joint docking, the degree of freedom between the connection assemblies at both ends is three.

According to the number ratio of the power systems to the targets, the docking mode can be divided into one-to-one docking and many-to-one docking forms. The one-to-one docking form indicates that a power system docks with a target, and the many-to-one docking form indicates that a plurality of power systems dock with a target.

Regarding the connection position, the orientation of the connection point on the target body can be usually simply divided into being below, in the lower part of, in the middle part of and in the upper part of the target body based on the stable state in the target parachute landing process. The orientation of below is directly below the target body. The lower part, the middle part and the upper part refer to the lower, middle and upper parts of the side of the target body. The power system can select the connection points and the combination of the connection points according to the task requirements, its own motion ability and the flexibility of docking.

The docking mode can use fall-catch and cooperative docking according to the task. The difference between the fall-catch and the cooperative docking is that the cooperative docking needs to provide a connection member that cooperates with the connection assembly of the power system on the target.

Tray-type connection assemblies are used for fall-catch, and such connection assemblies dock with the target from below the target. Usually, such a connection assembly is provided with a controllable clamping module for clamping the target. When the target falls on the “tray”, the clamping module clamps the target to improve the fixed connection relationship between the target and the “tray”.

Cooperative docking can be divided into flexible docking, quasi-rigid docking and rigid docking.

Flexible docking: the power system docks with the target by a flexible member. Common flexible connection includes the sling-loaded connection of a single flexible member and the cooperative sling-loaded connection of a plurality of flexible members.

Rigid docking: the power system docks with the target by a rigid member, and there is no degree of freedom between the power system and the target after docking.

Quasi-rigid docking: the power system docks with the target by a rigid member or a flexible member. After the docking, there are still degrees of freedom between the power system and the target, but from the control point of view, the power system and the target can be regarded as a rigid body or a rigid body with little change in parameters.

Step 4, the power system performs power recombination with the parachute landing target.

The objective of power recombination is to provide the target with controllable motion ability required by the task.

The content of power recombination includes:
adding the power system to the parachute landing target;
changing the structure and the composition of the power system on the basis of the connected system;
changing the power and dynamic characteristics of the parachute, or remove the parachute;
supplementing power supply sources to the target, such as fuel and electric energy;
a combination of the above.

1 ) The mechanical connection between the power system and the target is established through docking, so that the power system can apply a force on the target independently or in cooperation with the parachute to achieve control.

2 ) After the power system is connected with the target, the required dynamic performance can be obtained by changing the structure of the power system or the combined body of the power system and the target. When necessary, a more streamlined system composition is obtained by removing the subsequent unnecessary parts.

In some embodiments, the power system provides a dedicated power system for the characteristics of the target. After docking, the power supplement-based aircraft can be disengaged from the connection assembly and the target, so that only the dedicated power system is used to drive the target to achieve a better control effect.

In some embodiments, the specific power part of the power system is in a tightening state, and it is necessary to keep a small outer envelope size before the intersection and docking, which is beneficial to the flight performance of the power system. After docking, in order to provide better dynamic performance to the target, the specific power part can be expanded to a suitable state to obtain a larger driving torque with respect to the combined body centroid, thus obtaining better attitude controllability.

3 ) After the power system is connected with the target, the power (energy) source is supplemented to the target through means such as pipelines and electrical connection.

In some embodiments, the power system carries the fuel required by the target. When the power system docks with the target, the fuel pipeline docks with the corresponding connection member of the target at the same time. After confirming the correct connection of the pipeline, the power supplement refuels the target. After the power system refuels the target, the power system can be disengaged from the target, and the target uses its own driving system to move independently. Alternatively, the power system keeps connected with the target after refueling the target. The power devices of the power system and the target jointly drive the target to move.

4 ) The power of the parachute is changed, including releasing the power of the parachute, changing the power of the parachute by changing the parachute type or changing the parachute form, or keeping the power of the parachute.

There are the following ways to release the power of the parachute.

(1) The connection between the parachute and the target is disconnected. For example, the parachute rope and parachute are thrown away, or the parachute rope is cut. (2) The parachute form is changed to lose its original aerodynamic characteristics. For example, a device is used to retract the parachute to the target to lose aerodynamic ability of the parachute. (3) The parachute is destroyed to lose its original aerodynamic characteristics. For example, the parachute is burnt, or the preset hole in the parachute is opened. The power of the parachute is reserved, and at the same time, the power system is used to provide power to the target body. A typical example of such an application is that the reserved parachute is a ram-air parachute, and the supplemented power system can form a powered parafoil system with the ram-air parachute, so as to drive the target body to move in the form of a parawing. In this case, a controller for controlling a parachute on the target is often needed to obtain a better control effect. When needed, the power of the parachute can also be released as needed.

Step 5, the target is controlled to move to the desired position in the desired state or land in the desired state by controlling the recombined power system.

Taking the rescue of a parachute landing aircraft in the air as an example, the main goal of the task is to ensure the safety of personnel in the aircraft, and the second important goal is to ensure the structural safety of the aircraft. In this case, the landing site is uncertain, and the above goals shall prevail. The power system can screen feasible landing sites according to the surface information obtained off-line, and acquire the actual situation of alternative landing sites in real time according to its own state observation system. In combination with the dynamic performance, the motion state and the environmental information at the incident time of the target after supplementing power, the optimal landing site is selected. According to the actual situation, the optimal driving combination solution and the specific control solution are selected.

For rocket recovery tasks, the recovery site is clearly known. After the power system docked with the target, according to the motion state, the residual energy state, the distance from the recovery site, and the environmental information of the connected system, the appropriate motion trajectory or route is obtained. A reasonable power combination is used to fly to the recovery site, and cooperation with the ground recovery device is performed to complete rocket recovery if needed.

In order to further optimize the above power supplement and recovery method, the above Step 4 is divided into two links: power recombination and adjustment. The above Step 4 can be regarded as a power recombination link.

The adjustment link is as follows.

If the state of the target and the power system meets the dynamic requirements after docking, there is no need to adjust the state. If it is necessary to adjust the flight state of the target and the power system at a specific stage after docking, the combined body of the target and the power system should be adjusted to the flight state suitable for flight requirements. If the result of power recombination is the target itself, the forgoing “combined body” only refers to the target itself. After adjustment, the combined body should still be able to obtain effective power. For example, for the state adjustment of the target body swapping up and down, the power system can use propellers with positive and negative attack angles, so as to still provide the driving force for the system to overcome gravity after swapping up and down.

In some embodiments, after the power system docked with the target, the power of the power system or part of the power therein can be transferred to a more favorable position along the preset transfer device to provide better control performance to the target. For example, on a slender cylindrical target, the power system moves from below to above along the length direction of the cylinder, so that the centroid is located below the power system, and the combined whole obtains static stablility characteristics.

After docking, according to the task requirements, the two links of power recombination and adjustment can occur in the required number and order, which provides a flexible configuration solution for the subsequent controllable landing and recovery of the target.

For flexible connection, it is usually necessary to determine whether it is necessary to adjust the state according to the dynamic stability characteristics of the connected system. For example, in the case of bottom docking, it is usually necessary to adjust the relative state of the upper and lower parts to obtain a more stable dynamic state. Generally, it is unnecessary to adjust the state when the connection point is above the center of gravity for multi-machine coordinated redistribution and transportation.

For rigid connection, it can be determined whether adjustment is required according to the dynamic stability of the whole system after connection and the actual application scenarios. For example, in the case of bottom docking, if the power system can stably control the connected system, the state can be kept unchanged. For another example, if the auxiliary landing equipment requires the target body to be below the power system when landing, the state can be adjusted.

The present disclosure discloses a target controllable landing method based on parachute landing and power supplement, which includes a parachute landing stage and a power supplement stage. The parachute landing stage refers to the use of parachutes to control the initial motion state of the target in the air, and the power supplement stage refers to the use of the above power supplement and recovery method for the parachute landing target to control the later motion state of the target.

The parachute landing stage is as follows.

According to the overall control solution, the target starts from the initial place, moves to the set throwing area to throw the target, and the target enters the throwing state.

The target falls from the air and the parachute is opened at the right time.

The target can carry more than one type and more than one set of parachutes, so as to build the parachute power more flexibly. For example, the conventional parachute landing manner includes a main parachute, and the guide parachute cooperating with the main parachute.

In some embodiments, the parachute carried by the target can have its own controller to provide a certain degree of control capability, such as a ram-air parachute.

In some embodiments, after the target is thrown, the target emits its own motion state information in real time, including global coordinate information and attitude information. For example, a positioning device is installed on the target to acquire coordinate information. An inertial navigation system is installed on the target to obtain the attitude of the target. It is also necessary to arrange a communication device for sending information.

In some embodiments, after the target is thrown, the target can emit detectable information for the outside world to know, locate and track, such as optical information emitted by a visible light lamp, or an invisible light lamp with high brightness, or an acoustic signal with a specific wavelength and a specific variation law, or a radio signal with a specific wavelength and a specific variation law.

In some embodiments, the target has high detectability, such as installing a Luneburg lens.

The target enters a deceleration and descent state, and moves towards the target intersection area.

The power supplement stage is as follows.

The task at this stage is achieved by using the above power supplement-based controllable landing method for the parachute landing target, so that the target can move to the desired position in the desired state or land in the desired state.

The following embodiments are provided for a power supplement-based system for a parachute landing target and a power supplement-based controllable landing method for a parachute landing target according to the present disclosure.

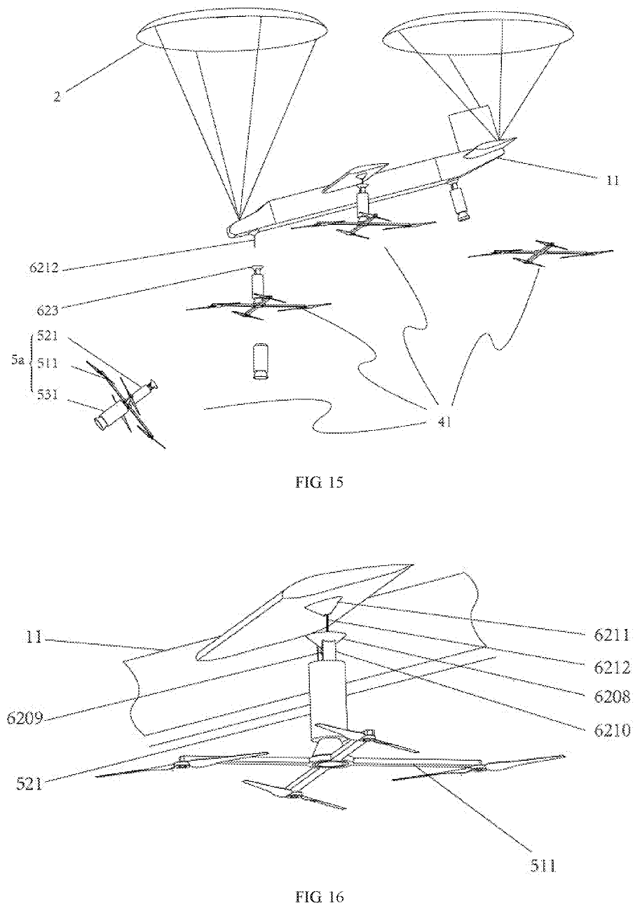

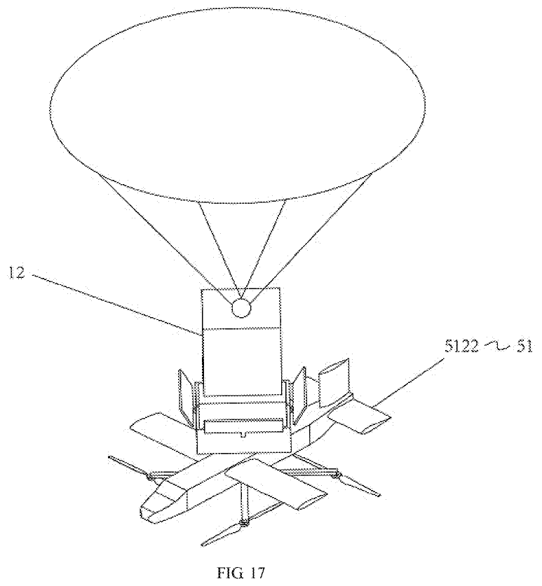

Embodiment 1: in FIG. 15 and FIG. 16, rescuing an aircraft in emergency is shown.

The target is the parachute landing target aircraft 11. The target aircraft 11 here can be an airplane to be rescued or a parachute landing return cabin returning to the earth. By using the solution and the system, the safety of passengers on board and the safety of the target aircraft 11 can be guaranteed to the greatest extent.

There is an emergency rescue system based on this system within the jurisdiction. The components of the power supplement-based system 3 are as follows: the power system 5 a consists of a large multi-rotor aircraft 511 and a booster rocket 521. The booster rocket 521 is mainly used to provide a sufficient thrust to the power system 5 a to reach the high speed required for emergency response. The multi-rotor aircraft 511 is further provided with a booster rocket 531. The booster rocket 531 is used to provide a large reaction thrust at the expense of a small weight before the airplane to be rescued lands, so as to alleviate the impact received by the multi-rotor aircraft 511 and passengers on board, and to provide a larger buffering thrust at the moment of landing. The connection assembly 623 is implemented by the connection assembly embodiment 5. The locking mechanism 6209 in the connection assembly 623 uses a roller winch, and the flexible member 6212 on the target connection member uses a guide rope. The state observation system consists of a radar system installed on the ground and an airborne visual observation system installed on the multi-rotor aircraft 511. The control system consists of a general controller installed in the ground rescue system and a controller installed on the multi-rotor aircraft 511.

In this embodiment, the power supplement-based unit 41 consisted of a plurality of power systems 5a and a connection assembly 623 provided thereon is used. A plurality of power supplement-based units 41 cooperatively perform tasks to complete power supplement of the target aircraft 11.

The emergency rescue system receives the distress signal, and the ground radar of the state observation system scans the airspace to obtain the motion state information of the target aircraft 11.

The general controller of the control system calculates the spatial coordinates of the intersection point of the power system 5a and the target aircraft 11 and other motion states based on the motion state information of the target aircraft 11 obtained by the radar in combination with the motion capability of the power system 5a according to the time optimal principle, and at the same time, solves the time optimal trajectory of the power system 5a flying to the intersection point. The general controller sends the calculation results to the controller on the power system and issues the instruction to start the task. When necessary, the calculation is completed by the controller of the power system.

According to the planned trajectory, the power system 5a quickly reaches the vicinity of the intersection point under the action of the booster rocket 531 and its own power, and updates the planned trajectory and adjusts the control output in time when necessary. The airborne visual observation system of the power system 5a observes the target aircraft 11. The booster rocket 531 is disengaged from other parts of the power system 5a. The rest of the power system 5 a continues to approach the intersection point of the target aircraft 11. When the distance from the target aircraft 11 is sufficient, the airborne state observation system of the power system 5 a measures the motion state information of the connection member on the target aircraft 11, especially the position and speed information with respect to the power system.

According to the agreement, the target aircraft 11 has extended the flexible member 6212 at several positions of the body. The power system 5a selects the connection point with the target aircraft 11 according to the motion information and other state information of the target aircraft 11 observed by the airborne visual observation system, and moves to the vicinity of the connection point depending on its own power, so that the connection assembly 623 carried by the power system 5a is close to the connection member of the target aircraft 11.

The power system 5a selects an appropriate path to fly to the vicinity of the connection part below the target aircraft 11, and then docks with the flexible member 6212 through its own dynamic performance, and quickly docks with the flexible member 6212 through the locking mechanism 6209, so that the cooperating surfaces of the connection devices at both ends are cooperated and locked. In this way, the initial power recombination is achieved.

The power system 5a searches for a suitable diversion area through its own global positioning information in combination with off-line geographic data and real-time meteorological information. The diversion area of the target aircraft 11 is observed and evaluated online by using the state observation system. Finally, the landing area with safe landing conditions is selected.

The power system 5a applies a force on the target aircraft 11, drives the target aircraft 11 in parachute landing to avoid the dangerous surface area and guides the target aircraft to the selected landing area.

When the target aircraft 11 is about to land, the power system 5a adjusts the attitude of the target aircraft 11 by the driving force of its own multi-rotor aircraft 511, so as to reduce the damage to members on board and the aircraft structure when the target aircraft 11 lands.

According to the buffer design, within a short distance from the ground before the target aircraft 11 lands, the booster rocket 521 is started to provide a buffer force to the aircraft to be rescued, so that the target aircraft 11 is minimally impacted when landing.

The structure of the power system 5a in this embodiment is a power supplement-based aircraft 51 consisted of a multi-rotor aircraft 511 and a booster rocket 521, and a booster system 53 that a booster rocket 531 acts as. In some specific application scenarios, power can be further recombined based on the above solution. For example, when the target aircraft 11 is about to land, the multi-rotor aircraft 511 is disengaged from the booster rocket 521. In this case, the power system 5a is reallocated into the dedicated power system 52 that the booster rocket 531 is used as, the power supplement-based aircraft 51 that the multi-rotor aircraft 511 is used as, and the booster system 53 that the booster rocket 531 is used as.

In some embodiments, the dedicated power system includes one or more booster rockets. The dedicated power system is connected to one or more positions of the target aircraft. Within a short distance from the ground before the target aircraft lands, the booster rocket is started to provide the torque and the buffer force needed for the attitude adjustment to the target aircraft to ensure the safety of the aircraft and the people on board.

In the case of rescuing the return cabin, if the return cabin is affected by the parachute 2, the return cabin cannot be dragged to a safe landing site. The parachute 2 can be thrown away in time for further power recombination, and the return cabin has high maneuverability when being driven by the power system 5a, thus reaching a safe landing site.

Embodiment 2: airborne materials are received.

The power supplement-based system and method can achieve accurate reception of airborne materials 12. Because the requirement of the materials 12 is only parachute landing, it is beneficial to the batch transportation of the materials 12 on a transport aircraft.

As shown in FIG. 7, the power supplement-based aircraft 51 uses an unmanned helicopter 5121. The connection assembly 611 is carried on the helicopter 5121, which is implemented by the connection assembly in Embodiment 1. The materials 12 are dropped in the predetermined airspace at the specified time and enter the parachute landing state.

The power system 5b performs long-distance observation or ascends for patrol according to the specified time and predetermined airspace.

When the materials 12 are identified, the helicopter 5121 flies to materials 12 and is intersected and docks with the materials 12.

The small parachute retractor 211 on the materials 12 retracts the parachute into the parachute retractor 211, thereby releasing the aerodynamic force of the parachute 2.

The helicopter 5121 carries the materials 12 and delivers the materials to the destination accurately.

In some cases, a differential GPS module and a wireless communication module are installed on the helicopter receiving the materials and the materials, and the helicopter and the materials acquire each other's coordinates through wireless communication. The high-precision data of the differential GPS is used as the observation result to provide the basis for the undertaking action.

In some cases, as shown in FIG. 8, the connection assembly 612 of the helicopter 5121 is implemented by the connection assembly in Embodiment 2. The connection assembly 612 and the target are bonded by a hook and loop 6104 to ensure the reliability of the connection.

In some cases, as shown in FIG. 13, for some slender materials, the connection assembly 625 on the helicopter 5121 can be implemented by the connection assembly in Embodiment 7. Because there are three remaining degrees of freedom after docking, the docking belongs to flexible docking. The helicopter 5121 can move the materials 12 to the position under the helicopter 5121 by a maneuvering action. The helicopter 5121 continues to provide an effective pulling force to the materials 12 by adjusting the pitch angle.

In some cases, as shown in FIG. 17, in order to give consideration to the convenience of deployment and the timeliness of intersection, the power supplement-based aircraft 51 takes the form of a vertical takeoff and landing aircraft 5122. After the vertical takeoff and landing aircraft 5122 is intersected with the materials 12, the vertical takeoff and landing aircraft can be converted into the vertical takeoff and landing mode to dock with the materials 12. Alternatively, under the condition of sufficient control accuracy, the fixed-wing flight mode is used to complete docking with the materials 12.

For a target controllable landing system based on parachute landing and power supplement and a target controllable landing method based on parachute landing and power supplement, the following embodiments are provided.

Embodiment 3: a rocket is recovered, and the overall task is to make the rocket body land to the designated place without damage after launch for subsequent use.

The system and method can preserve the rocket body. Compared with the solution of discarding after launch, the system and method save a lot of rocket launch cost. Compared with the rocket recovery solution depending on its own fuel and power recovery, the system and method save a lot of fuel, that is, the size of the rocket is greatly reduced. Moreover, since the power supplement-based system can provide a landing gear to the rocket, the extra payload of the rocket can be further reduced, or from another perspective, the effective payload of the rocket is increased.

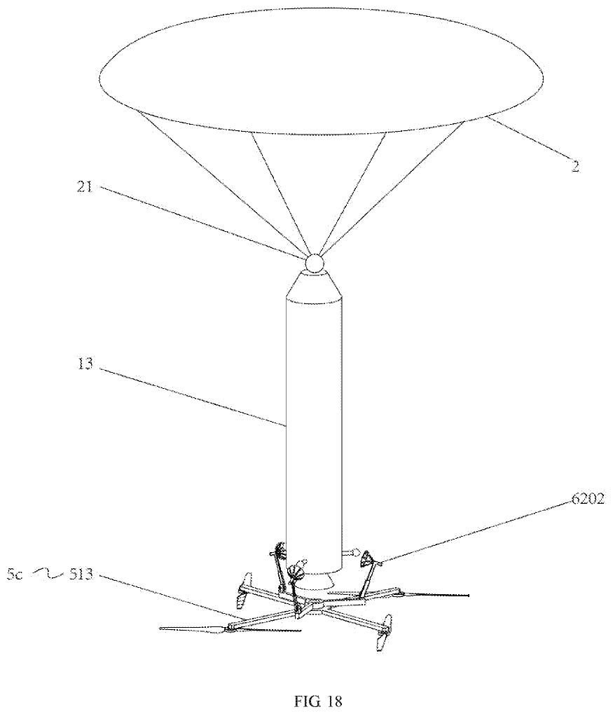

As shown in FIG. 18, the power supplement-based aircraft is a large multi-rotor helicopter or a coaxial twin-propeller helicopter, which is collectively referred to as the helicopter 513 here. The connection assembly 621 is implemented by the connection assembly in Embodiment 3. The mechanical arm 6202 has a locking function, so that the driver of the mechanical arm 6202 can be prevented from being stressed after docking. The state observation device includes a ground radar, an optical tracking system, a GPS sensor or an integrated navigation system with a global positioning function and communication device which is installed on the rocket body 13 to be recovered and the helicopter 513.

As a part of the rocket system, the rocket body 13 to be recovered is launched together with other parts of the rocket, and after the fuel is exhausted, the rocket body is disengaged from other parts and enters an unpowered throwing state.

The rocket to be recovered is equipped with a parachute and a parachute control device 21. When the rocket enters the atmosphere at a certain height, the parachute control device 21 opens the parachute 2 and the rocket body 13 to be recovered enters the parachute landing state. The lower part of the rocket body 13 to be recovered is provided with three ball-shaped connection members 6204.

The rocket body 13 to be recovered sends its global motion state information, especially position and speed information, to the outside in real time through wireless communication.

The state observation system detects the motion state information emitted by the rocket body 13 to be recovered in real time. When necessary, an active detection means can be used, including real-time scanning by a ground radar, and accurate tracking by an optical tracking system after acquiring preliminary information of the rocket to be recovered. The general controller of the control system calculates the intersection point or the intersection area according to the information of the rocket to be recovered, and meanwhile calculates the motion trajectory of the power system, sends the calculation result to the controller of the power system, and issues the instruction to start the task in real time. When necessary, the calculation is completed by the controller of the power system.

The power system 5c can depart from the recovery point or select other suitable places to depart from, such as an airspace near the descending route of the rocket body 13 to be recovered. For example, at high altitude in the parachute landing area, the power system 5c is carried on the aircraft, and the aircraft stands by near the parachute landing area. After receiving the task start instruction, the power system 5c departs from its carrier and flies to the intersection point.

In the intersection process, the power system 5c can adjust the motion trajectory according to the motion information of the rocket body 13 to be recovered obtained in real time. When the distance between the power system 5c and the rocket body 3 to be recovered is close enough, the airborne state observation system of the power system 5c measures the motion state information of the connection member on the rocket body 513 to be recovered, especially the position and speed information with respect to the power system 5c. The helicopter 513 moves to the position below parachute landing rocket body 13 to be recovered, thus completing docking.

The rocket body 13 to be recovered releases the parachute 2. The helicopter 513 drives the rocket body to be recovered to be disengaged from the parachute by a maneuvering action, and enters the landing route.

When necessary, the helicopter 513 can move the rocket body 13 to be recovered to the position below the helicopter 513 by a maneuvering action, so as to make the whole system have static stability, improve the controllability in the moving process and complete the adjustment action.

After the rocket body 13 to be recovered moves to the recovery site, the landing gear of the helicopter 513 touches the ground to support the rocket body to be recovered.

For the case where the helicopter 513 departs from high altitude, the helicopter 513 can take advantage of high altitude, and uses a manner of autorotation landing or a combination of autorotation landing and normal landing. The potential energy that the helicopter 513 and the rocket body 13 to be recovered have at high altitude is converted into the kinetic energy of the propeller, thus greatly reducing the energy required to be carried by the power system.

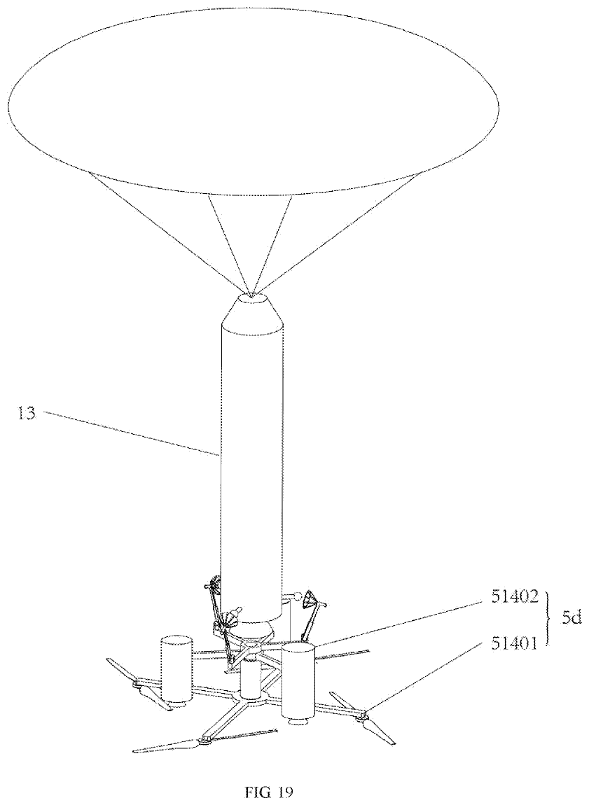

In Embodiment 4, as shown in FIG. 19, based on Embodiment 3, the power system 5d can consist of a multi-rotor helicopter 51401 and a rocket propulsion device 51402. After completing docking, the parachute control device releases the parachute. The multi-rotor helicopter 51401 drives the rocket body 13 to be recovered to fly to the recovery site. The rocket propulsion device 51402 provides the thrust to overcome the weight of the rocket body 13 to be recovered by taking advantage of its large thrust-to-weight ratio. The multi-rotor helicopter 51401 can take adjusting the attitude of the rocket body 13 to be recovered as the main task, thus reasonably utilizing the flying weight of the power system 5d.

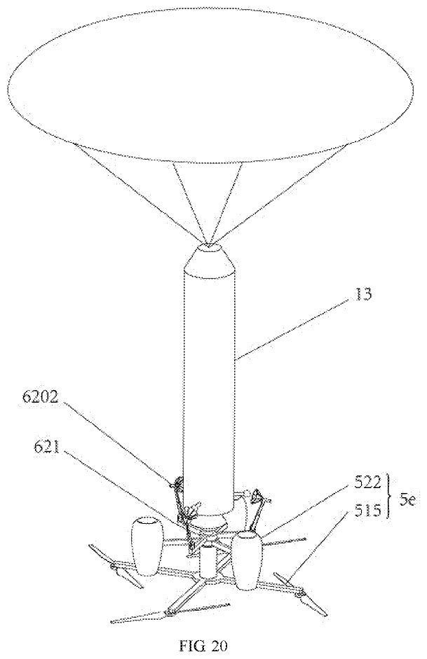

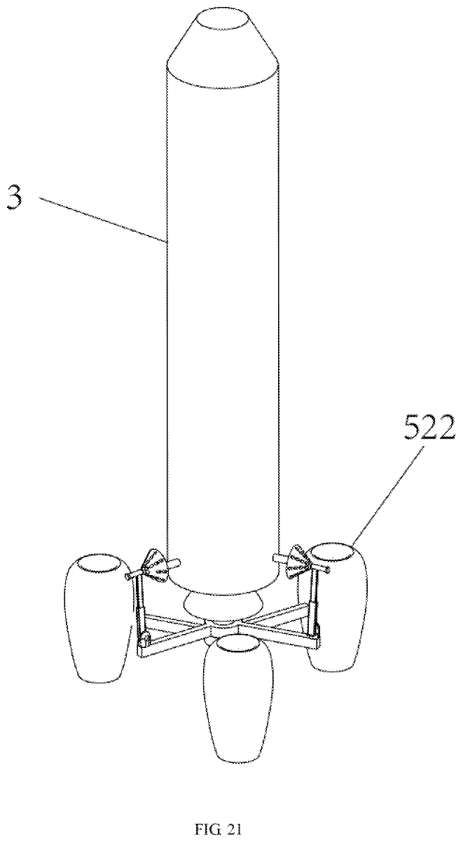

In Embodiment 5, as shown in FIG. 20 and FIG. 21, based on Embodiment 3, the dedicated power system 52 uses a small jet engine 522. The power system 5e includes a combination of a dedicated jet engine 522 and a helicopter 515. The connection assembly 621 uses the two-stage combined connection assembly with the mechanical arm and rigid docking as described in Embodiment 3. This embodiment is the same as Embodiment 3 in general, and only the different parts are described here.

The helicopter 515 and the jet engine 522 are intersected with the rocket body 13 to be recovered. The tolerance of the rigid connection member installed on the jet engine 522 is small, so that the helicopter 515 cannot achieve its rigid docking depending on its own control accuracy. The mechanical arm 6202 is used to achieve large tolerance docking, and then the rigid connection member is guided by controlling the mechanical arm 6202. After reaching the tolerance range of the rigid connection member, the rigid connection member is connected and locked. The rocket body 13 to be recovered is disengaged from the parachute at the right time. The helicopter 515 is disengaged from the jet engine 522. Subsequent recovery/landing work is completed by the jet engine 522.

Of course, when necessary, the helicopter 515 and the jet engine 522 are not disengaged, and jointly complete the subsequent recovery/landing work. In this case, the combination of the helicopter 515 and the jet engine 522 can be regarded as the power supplement-based aircraft 51.

When necessary, a plurality of jet engines 522 can be provided and distributed around the rocket body, which is beneficial to improve the torque output and enhance the attitude controllability. Furthermore, the distance between the jet engine and the center is adjustable, so as to have a wider range of use.

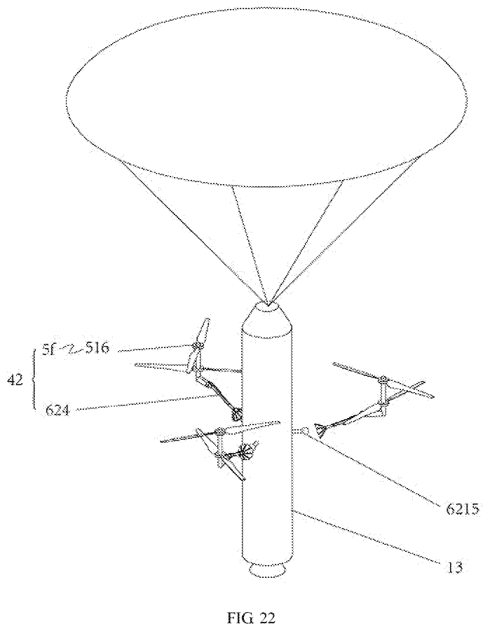

In Embodiment 6, as shown in FIG. 22, for the rocket recovery in Embodiment 3, the power system 5f can be a power supplement-based unit 42 consisted of a plurality of helicopters 516 and a cooperative connection assembly 624. The advantage of using a plurality of helicopters 516 is that the recovery of a large rocket can be achieved through the coordinated redistribution and transportation of a plurality of helicopters 516. The ball-shaped connection members 6215 on the rocket body 13 to be recovered are distributed on the circumference of the rocket body 13 to be recovered. The cooperative connection assembly 624 provided on the helicopter 516 is implemented by the connection assembly in Embodiment 6. After an appropriate number of helicopters 516 are intersected with the rocket body 13 to be recovered, the helicopters move to the vicinity of their respective connection members and enables their own connection assemblies to approach the corresponding connection members. According to the preset docking solution and algorithm, the docking is completed in time. After being disengaged from the parachute, a plurality of helicopters 516 take the rocket body 13 to be recovered back to the recovery point through collaborative transportation.

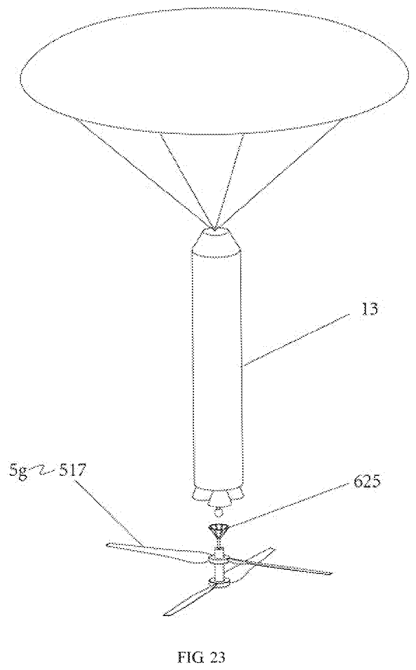

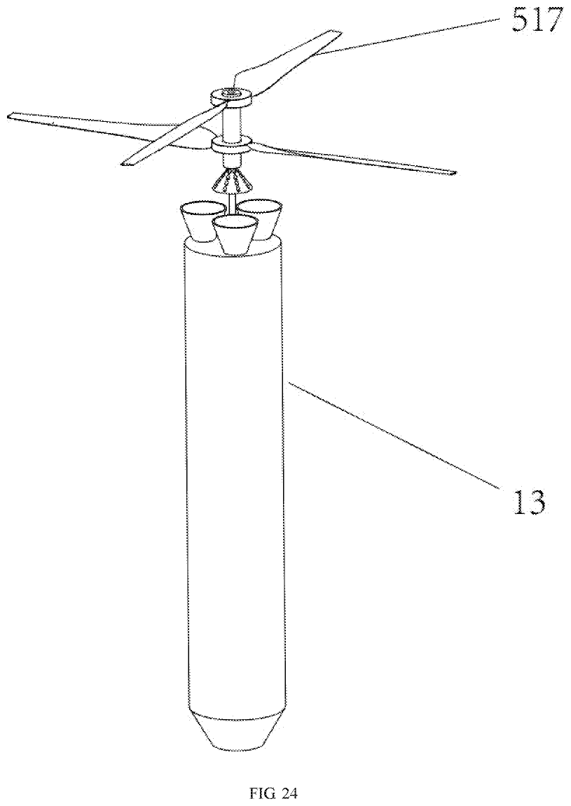

In Embodiment 7, as shown in FIG. 23 and FIG. 24, for the rocket recovery in Embodiment 3, the power supplement-based aircraft 51 in the power system 5g uses the helicopter 517. The docking mode can be implemented by the connection assembly in Embodiment 7. After the helicopter 517 docked with the rocket body 13 to be recovered, the helicopter 517 can move the rocket body 13 to be recovered to the position below the helicopter 517 by a maneuvering action, so as to allow the whole system to have static stability, improve the controllability in the movement process, and complete the adjustment action.

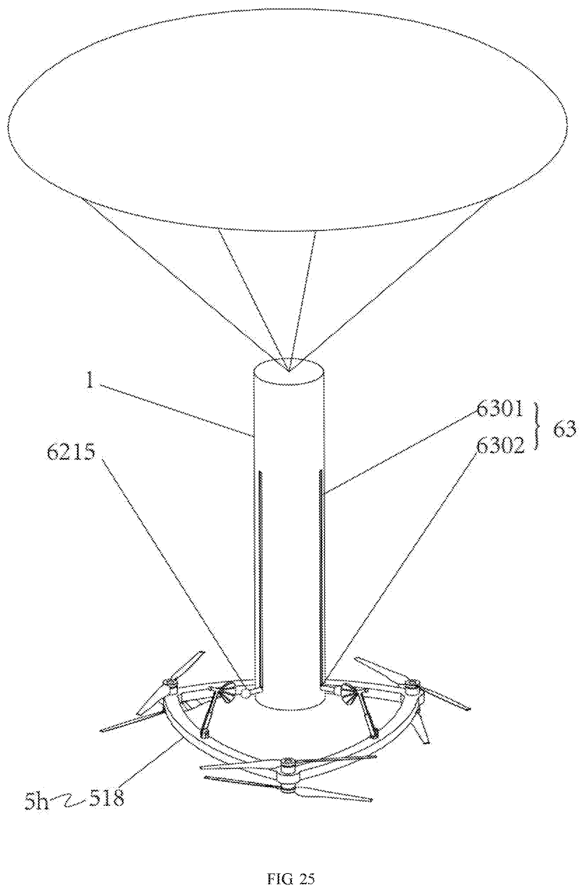

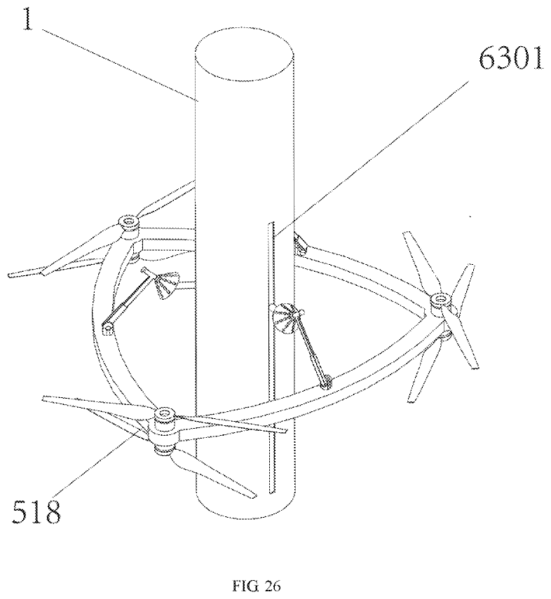

In Embodiment 8, as shown in FIG. 25 and FIG. 26, the recovery of a slender target is involved, such as the rocket in the above embodiment. The aircraft 518 uses an annular structure. The docking mode between the power system 5h and the target 1 can be implemented by the connection assembly in Embodiment 6. The target 1 is provided with a transfer assembly 63. The transfer assembly 63 includes a guide rail 6301 arranged along the length direction of the target 1 and a slider 6302 slidably arranged on the guide rail 6301. The ball-shaped connection member 6215 is installed on the slider 6302. After the power system 5h docked with the target 1, the power system 5h can be transferred to a more favorable position along the preset transfer assembly 63 to provide better control over the target 1. Therefore, the power system 5h moves from below to above along the length direction of the target 1, so that the centroid is located below the power system 5h, and the combined whole can obtain static stablility characteristics.

Although embodiments of the present disclosure have been shown and described, it will be understood by those skilled in the art that various changes, modifications, substitutions and variations can be made to these embodiments without departing from the principle and the spirit of the present disclosure. The scope of the present disclosure is defined by the appended claims and their equivalents.

1. A power supplement-based controllable landing method for a parachute landing target, comprising:
acquiring motion information of a target, and obtaining a desired state required for a power system to be intersected with the target;
intersecting and connecting the power system with the target; and
allocating, by the power system and the target, power resources in a power recombination manner according to task requirements, and driving the target to move to a desired position or land in a desired state;
wherein the power system comprises a driving device for providing a controllable driving force to the target.

2. The power supplement-based controllable landing method according to claim 1, wherein power recombination comprises connecting the power system with the parachute landing target.

3. The power supplement-based controllable landing method according to claim 1, wherein power recombination comprises throwing away or retracting a parachute according to task requirements after connecting.

4. The power supplement-based controllable landing method according to claim 1, wherein the power recombination comprises optimizing a structure and/or composition of the power system for one or more times in combination with the task requirements.

5. The power supplement-based controllable landing method according to claim 1, wherein the method further comprises adjustment,
wherein the adjustment comprises, after the power system is connected with the target, according to the task requirements, changing a relative attitude of a power and the target in a target coordinate system, and/or changing a relative attitude of the power and the target in a global coordinate system.

6. The power supplement-based controllable landing method according to claim 5, wherein the method comprises performing the power recombination for several times and/or performing the adjustment for several times according to the task requirements.

7. The power supplement-based controllable landing method according to claim 1, wherein a structure and/or composition of the power system are optimized according to the task requirements before the power system is connected with the target.

8. A target controllable landing method based on parachute landing and power supplement, comprising:
a parachute landing stage, in which a target state is controlled in a parachute landing manner; and
a power supplement stage, which is implemented by using the power supplement-based controllable landing method according to claim 1, so that the target moves to the desired position in a desired state or lands in the desired state.

9. A power supplement-based system for a parachute landing target, comprising:
at least one power supplement-based unit (4, 41, 42);
a state observation system, which is configured to acquire state information of a target; and
a control system, which is electrically connected with the power supplement-based unit (4, 41, 42) and the state observation system;
wherein the power supplement-based unit (4, 41, 42) comprises:
a power system (5, 5a-5h), which provides controllable power to a state of the target, wherein the power system (5, 5a-5h) comprises a power supplement-based aircraft (51); and
a connection assembly (6, 611,612, 621-626), wherein the connection assembly is configured to connect the power system (5, 5a-5h) and the target (1, 11-13), and is arranged in the power system (5, 5a-5h);
wherein the power supplement-based aircraft (51) is an aircraft powered by a power driving device or a combination of a plurality of aircrafts.

10. The power supplement-based system according to claim 9, wherein the power system further comprises a dedicated power system (52) which comprises at least one power driving device, and the power driving devices are connected and the dedicated power system (52) and the power supplement-based aircraft (51) are connected through connectors (54);
wherein a connector between the dedicated power system and the power supplement-based aircraft enables engagement or disengagement of devices at both ends.

11. The power supplement-based system according to claim 9, wherein the power system further comprises a booster system (53) which comprises at least one power driving device, the power driving devices are connected and the booster system (53) and the power supplement-based aircraft (51) are connected through connectors (54); and a connector between the booster system (53) and the power supplement-based aircraft enables engagement or disengagement of devices at both ends.

12. The power supplement-based system according to claim 9, wherein the power system uses a driving device with bidirectional or multidirectional power driving capability, or a combination of several driving devices.

13. The power supplement-based system according to claim 9, wherein the connection assembly comprises a fall-catch assembly (611, 612);
the fall-catch assembly (611,612) comprises:
a carrier; or
a carrier and a fastening device which is arranged on the carrier for fixing the target.

14. The power supplement-based system according to claim 9, wherein the connection assembly comprises a cooperative connection assembly (621-626);
the cooperative connection assembly (621-626) comprises a locking mechanism and a connection member which is arranged on the target and cooperates with the locking mechanism.

15. The power supplement-based system according to claim 9, wherein the state observation system comprises:
a device configured to acquire the state of the target; or
a device configured to acquire the state of the target and a state of the power system; or
a device configured to acquire the state of the power system and a motion state of the target with respect to the power system.

16. The power supplement-based system according to claim 9, wherein the control system comprises a controller arranged on the power supplement-based system, and/or
a controller outside the power supplement-based system.

17. A target controllable landing system based on parachute landing and power supplement, wherein the system comprises at least one parachute (2) and the power supplement-based system (3) according to claim 9.

18. The power supplement-based controllable landing method according to claim 2, wherein the method further comprises adjustment,
wherein the adjustment comprises, after the power system is connected with the target, according to the task requirements, changing a relative attitude of a power and the target in a target coordinate system, and/or
changing a relative attitude of the power and the target in a global coordinate system.

19. The power supplement-based controllable landing method according to claim 3, wherein the method further comprises adjustment,
wherein the adjustment comprises, after the power system is connected with the target, according to the task requirements, changing a relative attitude of a power and the target in a target coordinate system, and/or
changing a relative attitude of the power and the target in a global coordinate system.

20. The power supplement-based controllable landing method according to claim 4, wherein the method further comprises adjustment,
wherein the adjustment comprises, after the power system is connected with the target, according to the task requirements, changing a relative attitude of a power and the target in a target coordinate system, and/or
changing a relative attitude of the power and the target in a global coordinate system.
